(19) United States
(12) Patent Application Publication
(10) Pub. No.: US 2005/0065781 A1
(43) Pub. Date: Mar. 24, 2005

(54) Method for analysing audio signals

(76) Inventors: Andreas Tell, Konstanz (DE); Bernhard Throll, Oberursel (DE)

Correspondence Address: Flynn Thiel Boutell & Tanis, 2026 Rambling Road, Kalamazoo, MI, 49008-1631, US

(21) Appl. No.: 10/484,983

(22) PCT Filed: Jul. 24, 2002
(86) PCT No.: PCT/EP02/08256

(30) Foreign Application Priority Data
Jul. 24, 2001 (EP) 01117957.9

(51) Int. Cl. G10L 19/02

(52) U.S. Cl. 704/203; 704/207

(57) ABSTRACT

The present invention relates to a method for analyzing, separating and extracting audio signals. Due to the generation of a series of short-time spectra, a non-linear mapping into the pitch excitation layer, a non-linear mapping into the rhythm excitation layer, extraction of the coherent frequency streams, extraction of the coherent time events and the modeling of the residual signal, the audio signal can be decomposed into rhythm and frequency portions with which the signal can be further processed in a simple manner. The uses of said method are: data compression, manipulation of the time base, tune and formant structure, notation, track separation and identification of audio data.

### FIELD OF THE INVENTION

The present invention relates to a method for analyzing audio signals. By analogy with the function of the human brain, audio signals are analyzed in the present method with respect to frequency and time coherence. Data streams of the signals can be separated by extracting said coherences.

### PRIOR ART

The human brain reduces data streams supplied by the cochlea, the retina, or other sensors. Acoustic information is e.g. reduced on the way to the neocortex to less than 0.1%.

Therefore, data reduction by analogy with the human brain offers two advantages. On the one hand, a strong compression can be obtained; on the other hand, only information that would have been removed in the brain at any rate and is thus inaudible is lost during reduction of the data streams.

Psychoacoustic models try to imitate the phenomena of said reduction, cf. Auditory Perception—A New Analysis and Synthesis, Richard M. Warren, 1999 Cambridge University Press, but due to the principle they only yield very poor results in a direct comparison.

The type of data reduction can be explained with the help of the information theory. Neuronal networks try to maximize signal entropy. This process is extremely complicated and can hardly be described analytically and actually can only be modeled by learning networks.

A considerable drawback of this known method consists in the very slow convergence, so that it cannot be realized in a satisfactory way even on modern computers.

It is therefore the object of the present invention to provide a method with which acoustic data streams (audio signals) can be analyzed and decomposed with hardly any computing efforts such that, on the one hand, the separated signals can be compressed very easily or processed further in another way and, on the other hand, as little information as possible is lost.

### DESCRIPTION OF THE INVENTION

This object is achieved by a method for analyzing audio signals according to claim 1.

The following terms are used in the description of the invention:

A short-time spectrum of a signal a(t) is a two-dimensional representation S(f,t) in the phase space with the coordinates f (frequency) and t (time).

The definition used for coherence refers to typical characteristics of the autocorrelation function A_{S} of short-time spectra S:

$${A}_{S} ( t , f ) = {\int }_{- ∞}^{∞} S ( τ , ϕ ) {S}^{+} ( τ - t , ϕ - f ) ⅆ τ ⅆ ϕ$$

where S⁺designates the conjugated spectrum. When this function shows predictable behavior for t=0 and f=0, respectively, this is called frequency coherence and time coherence, respectively. This statement regards the whole short-time spectrum S; if one wants to learn something about local coherence, as in the following, only a section of S is used for evaluation.

Filters are defined by their action in the frequency domain. The filter operator \hat{F} acts on the Fourier transform ℑ as a frequency-dependent complex-valued evaluation h(f), which is designated as frequency response:
\hat{F}ℑ{a(t)}(f)=h(f)ℑ{a(t)}(f)
h(f)=|h(f)|e^{i arg(h(f))}=:g(f)e^{iφ(f)}

The frequency-dependent real quantities g(f) and φ(f) are designated as amplitude response and phase response, respectively.

Application of the inverse Fourier transform to the operator definition shows that the filter in the coordinate space acts as a convolution with \hat{F}⁻¹[h(f)]. Said convolution can be described as a scalar product with translation-symmetrical vectors V(t). Hence, a set of filters with different hₙ(f) yields a short-time spectrum according to the above definition. In the case of bandpass filters where h(f) virtually disappears except for a finite interval, a bank of filters can be used for representing short-time Fourier spectra or wavelet spectra. In the first instance, the different hₙ(f) are created by shifting a predetermined h(f); in the second instance, by scaling the frequency axis. In Fourier spectra the hₙ(f) have a constant bandwidth; by contrast, in wavelet spectra they have a constant quality (constant Q).

In streams and events, parts of the phase space are combined that have the same type of coherence and are coherent. Streams refer to frequency coherence, events to time coherence. An example of a stream is thus a monophonic melody line of an instrument that is not interrupted. By contrast, an event may be a drumbeat, but also the consonants in a song line.

The method according to the invention is based on the coherence analysis of audio signals. Like in the human brain, a distinction is made between two coherent situations in the signals: on the one hand, time coherence in the form of simultaneousness and rhythm and, on the other hand, coherence in the frequency domain which is represented by harmonic spectra and leads to the perception of a specific pitch. A reduction of the complex audio data to rhythm and tonality is thus carried out, whereby the demand for control data is reduced considerably.

To start data processing, a series of short-time spectra must first be prepared; these are needed for further analysis. Subsequently, the excitation of the pitch layer is produced with a non-linear mapping; a further non-linear mapping yields the excitation of the rhythm layer. The extraction of the coherent frequency streams and of the coherent time events is then carried out. Finally, the remaining residual signal is modeled.

The separated streams can be compressed in an excellent way because of their low entropy. In an optimum case a compression rate of more than 1:100 is achieved without any audible losses. A possible compression method is described following the separation method.

The steps of the method according to the invention and advantageous embodiments and various applications will now be described.

Generation of the Short-Time Spectra

The short-time spectra are advantageously generated by means of short-time Fourier transform, wavelet transform, or by means of a hybrid method consisting of wavelet transform and Fourier transform.

The Fourier transform can be employed by using a window function w(t), which is localized in time at t₀=0, for producing a short-time spectrum:
S(tₒ,f)=ℑ{a(t)w(t−t₀)}(f)

The window function substantially influences the bandwidth of the individual filters that have a constant value independently of f. The frequency resolution is thus the same over the whole frequency axis. The generation of a short-time spectrum by means of a Fourier transform offers the advantage that fast algorithms (FFT, fast Fourier transform) are known for the discrete Fourier transform.

The wavelet transform (WT) is obtained by defining a mother wavelet M(t) with the characteristics ℑ{M(t)}(0)=0 and

$${\int }_{- ∞}^{∞} {M}^{+} ( t ) M ( t ) ⅆ t = 1.$$

The transform is then:
S(t₀,f)=<f*M((t−t₀)*f)|a(t)>.

The frequency axis is here homogeneously subdivided logarithmically, so that log(f) is reasonably considered as the new frequency axis. The wavelet transform is equivalent to a bank of filters with h_{f0}(f)=ℑ{M(t)}(f/f₀). Due to their logarithmic subdivision said transform offers the great advantage that it imitates the frequency resolution of the human ear. Fast wavelet transforms are based on the evaluation of a general WT on a dyadic phase space grid.

The advantages of Fourier and wavelet transforms can be combined by using hybrid methods. First of all, a dyadic WT is here carried out by recursive halving of the frequency spectrum with complementary highpass and lowpass filters. For realization a signal a(n Δt), n ε N is needed on a discrete time raster, as is present in the computer after digitalization. Moreover, use is made of the operations Ĥ and \hat{T}, which correspond to the two filters. To use the method in a recursive way, the signal rate must be halved, which is achieved by the operator \hat{D} removing all of the odd n. Inversely, Û inserts a zero after each discrete signal value to double the signal rate. The bands produced by the dyadic WT can then be numbered continuously, starting with the highest frequency:
Bₘ(n)=\hat{D}Ĥ(\hat{D}\hat{T})^{m}a(nΔt).

The fast computing speed is due to the recursive evaluability of the band Bₘ over Bₘ₋₁.

The scaling of the frequency axis is logarithmic. To increase the resolution of the transform, each band signal Bₘ (n) can be further subdivided linearly with a discrete Fourier transform. The individual Fourier spectra must be mirrored in their frequency axis because the upper part of the spectrum is folded downwards by the operator \hat{D} to Ĥ. As a result, a piecewise linear approximation of a logarithmically resolved spectrum is obtained. Depending on the window used for the discrete Fourier transform, the resolution can here achieve very high values.

Non-Linear Pitch Excitation

In case of frequency correspondence, as felt by the brain, between a tonal event and a sinusoidal vibration offered for comparison, the frequency f thereof is defined as the pitch. The pitch scale is advantageously logarithmized to adapt it to the frequency resolution of the human ear. Such a scale can be mapped linearly on musical note numbers.

The pitch excitation layer (PEL) represents a time-dependent state PEL,(p)ε R with p=a log(f)+b and a,b mapping constants, which assumes its maximum at pₘₐₓ. The maximum indicates the pitch that is dominant at time t. Further local maxima are also indicative of existing pitches in the case of polyphonic signals. The PEL imitates the pitch excitation in the cortex of the human brain in that frequency coherences are analyzed.

There are various possibilities of producing pitch excitation. Possible are, inter alia, neuronal networks. For example, neuronal networks can be used with feedback member and perception inertia of the type ART (Adaptive Resonance Theory). Such a model for expectation-controlled stream separation has been described in a simple form in Pitch-based Streaming in Auditory Perception, Stephen Grossberg, in: Musical Networks—Parallel Distributed Perception and Performance, Niall Griffith, Peter M. Todd (Editors), 1999 MIT Press, Cambridge.

A simpler and therefore particularly suited possibility is the use of a deterministic mapping of the short-time spectrum into the PEL. This has the advantage that said mapping can be split into two partial mappings. In a first mapping, the logarithm of the spectral magnitude is taken:
L(t,f)=log (abs(S)t,f))).

The second mapping, in turn, consists of different parts. First, the correlation of L(t, f) is calculated with an ideal harmonic spectrum. Then, spectral echoes of a tone are suppressed in the PEL, the echoes corresponding to the position of possible harmonics.

To increase the contrast and to suppress less pronounced portions of the spectrum, it is of advantage to inhibit the spectrum laterally. Said lateral inhibition can be carried out after the calculation of L(t, f), after correlation or also after echo suppression. According to the example given by nature, a non-linear mapping can be used for lateral inhibition.

To reduce the work burden, it is of advantage to carry out lateral inhibition with a linear mapping. As a result, the whole second mapping of the pitch excitation becomes a linear mapping and can be written as a product of matrices. In a preferred embodiment, a first matrix H carries out lateral inhibition; in this process the contrast of the spectrum is increased to supply an optimum start basis for the subsequent correlation matrix K. The correlation matrix is a matrix that contains all of the possible harmonic positions, thereby producing a correspondingly large output at the location with maximum correspondence of the harmonic spectrum. Subsequently, lateral inhibition is again carried out. Thereupon, a “decision matrix” U suppresses the spectral echoes of a tone in the PEL, which correspond to the position of possible harmonics. In the end, lateral inhibition is again carried out. Depending on the form of the individual mappings, it is necessary to arrange a respective matrix M upstream or downstream to free the spectral vector of the mean value.

In a preferred embodiment, the matrices may have the following shape. The size of the correlation matrix Kⱼⁱ corresponds to the length of the discrete spectrum and is designated by N. The entries may then have the form

$${K}_{j}^{i} = {α}_{j} {\sum }_{i = 1}^{P} exp ( - {{ρ}^{2} ( i - 1 - {d}_{jl} )}^{2} ) ∈ {ℜ}^{N \times N}$$

where αⱼ is chosen such that

$${\sum }_{i}^{} {( {K}_{j}^{i} )}^{2} = 1.$$

In cases where the short-time spectra have been determined with pure Fourier or wavelet transforms

$${d}_{jl} = \{ \begin{matrix}{la2}^{b ( j - 1 )} , for spectra with linear f \text{-} axis \\ {log}_{2} l + {log}_{2} a + b ( j - 1 ) , for spectra with logarithm . f \text{-} axis .\end{matrix}$$

a,b must be chosen according to the spectral section to be analyzed, P is the number of harmonics to be correlated. The constants used follow from the position of the data of interest in the spectrum and can be chosen in a relatively free way. The number of harmonics should be between about 5 and 20 because this corresponds to the number of the harmonics that really occur. The constant ρ is determined empirically. It compensates the width of the spectral bands. For the hybrid method the correlation matrix can be constructed piecewise in a corresponding way.

The spectral echoes corresponding to the position of possible harmonics can be suppressed with the matrix Uⱼⁱ.

$${U}_{j}^{i} = {α}_{j} {\sum }_{l = - P}^{P} ( 2 {δ}_{01} - 1 ) exp ( - {{ρ}^{2} ( i - 1 - ( i + {b}^{- 1} {log}_{2} l ) )}^{2} )$$

with δ₀₁ the Kronecker symbol; the αⱼ are chosen such that

$${\sum }_{i}^{} {( {U}_{j}^{i} )}^{2} = 1.$$

For lateral inhibition matrix Hⱼⁱ can be chosen with
Hⱼⁱ−αⱼ(exp(−ρ₁²(j−i)²))−s exp (−ρ₂²(j−i)²)
where the constants s>0 and ρ₁>ρ₂ are to be determined empirically; the αⱼ are chosen such that

$${\sum }_{i}^{} {( {H}_{j}^{i} )}^{2} = 1.$$

For the correct function of the above matrices, the spectral vector must be without mean value. The matrix Mⱼⁱ can be used for this purpose:

$$M = I - \frac{1}{N} E ,$$

where I designates the N-dimensional identity matrix and Eⱼⁱ=1, i,j=1,K,N.

With the definition \tilde{H}=MHM, the linear portion of the PEL mapping can be written as
A=\tilde{H}U\tilde{H}K\tilde{H}.

To calculate the excitation matrix, the logarithmic spectrum must be mapped with A:
PL(t,p)=AL(t,f).

The pitch spectrum produced in this way shows pronounced distinctions for all tonal events occurring in the audio signal. To separate the events, a multitude of such pitch spectra can be produced at the same time. These inhibit one another, so that another coherence stream manifests itself in each spectrum. When each of said pitch spectra has assigned thereto a copy of its frequency spectrum, it is even possible to produce an expectation-controlled excitation in the pitch spectrum via feedback into the same. Such an ART stream network is excellently suited for modeling characteristics of human perception.

It is advantageous to recognize the streams by searching for time-coherent local maxima on the pitch axis and to calculate the pitch data therefrom as a time series. These stream data will be used later for extracting the coherent data.

Non-Linear Rhythm Excitation

Sudden changes on the time axis of the short-time spectrum, so-called transients, are the basis for rhythmic sensation and represent the most conspicuous time coherence within a short time window.

Rhythmic excitation is to react at a low frequency resolution and a relatively high time resolution to events with strong time coherence. It is obvious to newly calculate a second spectrum with a lower frequency resolution for this purpose.

To reduce work, it is of advantage to exploit the already existing spectrum for this purpose. The basis for the linear mapping into the rhythm excitation layer (REL) is then the logarithmic spectrum L(t, f). The mapping to be used can be described by two steps.

In a first step, the frequency components are averaged to obtain an improved signal/noise ratio. In a preferred embodiment, which is adapted to the above-described matrices, the matrix Rⱼⁱ for frequency noise suppression has the form
Rⱼⁱ=exp(−σ²(i−1−dⱼ)²)εR^{N×N}
with

$${d}_{j} = \{ \begin{matrix}{a2}^{b ( j - 1 )} , for spectra with linear f \text{-} axis \\ {log}_{2} a + b ( j - 1 ) , for spectra with logarithm . f \text{-} axis .\end{matrix}$$

Constants a,b are to be chosen as above according to the spectral section to be analyzed in order to compare the PEL with the REL. Constant σ controls frequency blurring and thus noise suppression.

In the human brain a time correlation is only possible over a very short interval. Therefore, in the second step of rhythm excitation, a differential correlation can be made without loss of essential information. Operator Ĉ for this mapping is here represented in an analytically continuous way, but can be discretized with standard methods.

$$\hat{C} x ( t ) := {\int }_{- ∞}^{∞} {\partial }_{t} x ( τ ) exp ( {{σ}_{1}^{2} ( t - τ )}^{2} ) - β exp ( {{σ}_{2}^{2} ( t - τ )}^{2} ) ⅆ τ$$

with 0<β<1 and σ₁>σ₂>0 as empirically determinable parameters.

The two operators commutate so that the composed mapping into the rhythm layer is given by
RL(t,p)=ĈRL(t,f)

The amount of RL throws light on the occurrence and frequency range of transients.

Extraction of the Coherent Frequency Streams

Since the PEL streams are well localized in the frequency domain, a filter structure is used for separating the stream from the remaining data of the audio stream. Advantageously, a filter with a variable center frequency is used therefor. It is of particular advantage when the pitch information from the PEL plane is converted into a frequency trajectory and the center frequency of the bandpass filter is thereby controlled. Hence, a signal of a narrow bandwidth is produced for each harmonic. The signal can then be processed by addition to the total stream, but can also be described by means of an amplitude envelope for each harmonic and pitch curve.

To erase the signal from the data stream, it must be removed. A phase shift can be introduced through the filter. In this instance, a phase adaptation must be performed after extraction. This is advantageously accomplished in that the extracted signal is multiplied by a complex-valued envelope of the amount 1. The envelope is used for achieving the phase compensation by way of optimization, for instance by minimizing the square error.

It is of advantage to perform amplitude adaptation of the extracted signal with the envelope as well. The pitch information is known from the PEL, so that a corresponding sinusoid can be synthesized that exactly describes the partial tone of the stream, except for the missing amplitude information and a certain phase deviation.

In a preferred embodiment, the sinusoid S(t) may have the following form:

$$S ( t ) = exp ( 2 π i {\int }_{0}^{t} nf ( τ ) ⅆ τ ) ,$$

where f(t) designates the frequency response from the PEL and n the number of the harmonic components. This envelope must now adapt the amplitude and also compensate the phase shift. The original signal can here be taken as a reference to measure and minimize the error of the adaptation. It is here sufficient to reduce the error locally and to work through the whole envelope step by step.

In case a filterbank has already been used for producing the PEL, this opens up another advantageous possibility of the frequency selection of the streams. From the known frequency response f(t), it is possible at any time to calculate the necessary frequency evaluation B(f,t) for the whole harmonic structure. From the known frequency responses hₙ(f), it is possible to calculate the coefficients with the help of which stream S(t) can be extracted as follows:

$$S ( t ) = {\sum }_{n = 1}^{N} 〈 {h}_{n} ( f ) \vert B ( f , t ) 〉 {b}_{n} ( t )$$

with Bₙ(t) the complex-valued frequency response of the n-th filter. In this case S(t) represents the complete extracted stream and has no phase shift because this was already corrected by the complex coefficients. The above formula, however, is only applicable to approximately orthogonal hₙ(f); normally, a correction member has to be supplemented.

Extraction of the coherent Time Events

In contrast to the PEL streams, the REL events in the frequency domain are poorly localized, but are fairly sharply defined in the time domain. The strategy for extraction must be chosen accordingly. First of all, a coarse frequency evaluation takes place that is derived from the event unsharpness in the REL. Since no special exactness is here required, it is of advantage to use FFT filters, analysis filterbanks or similar tools for the evaluation. In these, however, there should be no dispersion in the passband. The next step requires a time domain evaluation. Advantageously, the event is separated by multiplication with a window function. The choice of the window function must be determined empirically and can also take place adaptively. Hence, the extracted event can be obtained through
E(t)=W(t)ℑ⁻¹{H(g)ℑ{a(t)}}(t),
the signal a(t) is frequency-evaluated with H(f) and cut out with W(t).

Modeling of the Residual Signal

After extraction of the coherent frequency streams and time events the residual signal (residues) of the audio stream has no longer any portions that have coherences perceivable by the ear. It is only the frequency distribution that is still perceived. It is therefore of advantage to model said portions statistically. Two methods have turned out to be particularly advantageous for this purpose.

In a first method, several bands are used that contain frequency-localized noise. A frequency analysis of the residual signal supplies the mixing ratio; the synthesis then consists of a time-dependent weighted addition of the bands.

In a second method, the signal is described by its statistic moments. The time development of said moments is recorded and can be used for resynthesis. The individual statistic moments are calculated at specific time intervals. Advantageously, the interval windows are overlapping at 50% in the analysis and are then added in resynthesis, evaluated with a triangle window, to compensate for the overlap.

$${M}_{n} = {K}^{- t} {\sum }_{k = 1}^{K} {a}_{k}^{n}$$

designates the n-th moment of the random sequence aₖ. The distribution function of the random sequence can be calculated from the moments and an equivalent function can then be produced anew. The number of the analyzed moments should be much smaller than length K of the sequence. Exact values follow from hearing experiments.

Applications

The above-described method can advantageously be used for compressing audio data. To this end, the invention provides a method including the steps according to claim 20.

The streams and events that are separated by extraction show low entropy and can thus be very efficiently compressed in an advantageous way. It is of advantage when the signals are first transformed into a representation suited for compression.

First of all, an adaptive differential coding of the PEL streams may take place. One frequency trajectory is obtained per stream from the extraction of the streams and an amplitude envelope for each existing harmonic portion. For an efficient storage of said data a double-differential scheme is advantageously used. The data are sampled at regular intervals. Preferably, a sampling rate of about 20 Hz is used. The frequency trajectory is logarithmized to adapt it to the tonal resolution of the ear and quantized on this logarithmic scale. In a preferred embodiment, the resolution is about 1/100 half-tone. Explicitly stored is advantageously the value of the start frequency and then only the differences with respect to the preceding value. Use can here be made of a dynamic bit adaptation that produces virtually no data at stable frequency positions, such as long-lasting tones.

The envelopes can be coded in a similar way. In this case, too, the amplitude information is logarithmically interpreted to achieve a higher adapted resolution. After the envelope of the basic frequency has been coded by analogy with the frequency trajectory, the amplitude start value is stored with respect to each harmonic. Since the curve of the harmonic amplitudes strongly correlates with the fundamental tone amplitudes, the differential information of the fundamental tone amplitude is advantageously assumed as the change in the harmonic amplitude, and it is only the difference with respect to said estimated value that is still stored. In the case of harmonic envelopes this will only create significant data volumes if the harmonic characteristic changes to a considerable extent. The information density is thereby increased further.

The events extracted from the REL layer show low time coherence because of their time localization. It is therefore of advantage to use a time-localized coding and to store the events in their time domain representation. It often happens that the events are very similar to one another. Advantageously, a set of base vectors (transients) is therefore determined by analyzing typical audio data, wherein the events can be described by a few coefficients. Said coefficients can be quantized, thus providing an efficient representation of the data. The base vectors are preferably determined with neuronal networks, particularly vector quantization networks, as are e.g. known from Neuronale Netzwerke, Rüdiger Brause, 1995 B. G: Teubner Stuttgart.

Due to their statistic character, the residues can be modeled, as described above, by a time series of moments or by amplitude curves of band noise. A low sampling rate is sufficient for this type of data. By analogy with the coding of the PEL streams, it is here also possible to use differential coding with adaptive bit depth adaptation with which the residues only contribute to the data stream to a minimal degree.

As soon as the data have been transformed into a suitable representation, a statistic data compression can be carried out by entropy maximization. Particularly suited are here LZW or Huffmann methods.

The signals separated according to the above method are also well suited for manipulations of the time base (time stretching), the pitch (pitch shifting) or the formant structure, formant meaning the range of the sound spectrum in which sound energy is concentrated independently of the pitch. For these manipulations the synthesis parameters must be changed in a suitable way in the resynthesis of the audio data. According to the invention methods including the steps according to claims 25-28 are provided for this purpose.

The PEL streams are advantageously adapted to a new time base in that the time marks of their envelope or trajectory points from the PEL are adapted according to the new time base. All of the other parameters can remain unchanged. For changing the pitch, the logarithmic frequency trajectory is shifted along the frequency axis. To change the formant structure, a frequency envelope is interpolated from the harmonic amplitudes of the PEL streams. Said interpolation can preferably be carried out by time averaging. This results in a spectrum whose frequency envelope yields the formant structure. Said frequency envelope can be shifted independently of the base frequency.

The events of the REL remain invariant in the case of a change in tune and formant structure. Upon change in the time base, the time of the events is adapted accordingly.

Like the REL events, the global residues remain invariant in the case of tune changes. During manipulation of the time base the synthesis window length can be adapted in the case of moment coding. When the residues are modeled with noise bands, the envelope grid points for the noise bands can be adapted accordingly during manipulation of the time base. In the case of formant correction, the noise band representation is preferably used. In this case an adaptation of the band frequency can be carried out in accordance with the formant shift.

A further advantageous application follows from the notation of the audio data into musical notes. To this end the invention provides a method including the steps according to claim 29. In the method, the PEL streams are first grouped according to their harmonic characteristic. The group criterion yields a trainable vector quantizer which learns from examples predetermined for it. A group produced in this way can be converted by the frequency trajectories into a notation. The pitches can e.g. be quantized into the twelve-tone system and provided with characteristics such as vibrato, legato, or the like.

For the notation of percussive instruments, coincidences of REL events with low-frequency PEL events or residues must be recognized. To this end neuronal networks that are standard for pattern recognition tasks are used, as are e.g. also described in Neuronale Netzwerke, Rüdiger Brause, 1995 B. G. Teubner Stuttgart. The percussion beats identified in this way are then inserted into the notation.

According to the invention claim 30 provides a method with which a track separation of audio signals can be carried out in an advantageous way. The PEL streams must be grouped according to their harmonic characteristic and then synthesized separately. To this end, however, certain associations of REL events, PEL streams and residues must be recognized because these should be combined in a track resynthesized according to the instrument. This association can be determined deterministically to a limited degree only; preferably, neuronal networks as have been mentioned above are therefore used for this pattern recognition.

As soon as the tracks have been separated, they can be processed separately and newly mixed together. Apart from many other possibilities, individual instruments can be analyzed or replaced and voices can be faded out or amplified.

It is of advantage to use the method for analyzing audio signals for the global and local identification of audio signals, for which purpose the present invention provides a method including the steps according to claim 31 or 32. This identification is based on features that are also available to human perception as recognition features. With different criteria, different types of recognition can be obtained.

To identify a piece of music clearly as a piece stored in a database, the relative position and the type, i.e. the internal structure, of the streams and events must be compared. Internal structure of the melody line means, for example, features, such as intervals and long-lasting tones. This comparison with a database can be carried out deterministically and may first be limited to the interval sequences in an advantageous way. If this does not yield a definite identification yet, additional criteria may be used.

To determine the title of a piece of music independently of interpreters or recording circumstances, dominant structures must be found in the material. These structures can be identified deterministically by frequent repetitions or particularly high signal portions. The greater the number of such features corresponding to a comparison or reference piece, with changes in time base, tune or phrasation being admissible, the greater is the probability that the examined piece of music corresponds to the comparison piece. The comparison of melody lines may advantageously concentrate on the sequence of longer-lasting tones and in this instance, too, only on the sequence of the intervals. It often suffices to evaluate and include rhythmic information in a very coarse manner only because such information can strongly depend on the interpreter.

The method for analyzing audio data according to the invention can advantageously be used for identifying a singing voice in an audio signal. To this end the invention provides a method including the steps according to claim 33. To identify the singer of a piece of music, his voice is advantageously characterized through the formant structure. The typical formant position can be interpolated from the PEL streams, as has been described above. When the formant structures are compared with a database, the choice of possible singers can thus be restricted considerably; ideally, the singer can even be identified in a definite way.

In all of the above-mentioned identification methods, it is of advantage to use a hashing scheme at the beginning to restrict the selection by way of a checksum comparison with the database and it is only then that a detailed examination is carried out.

The method for analyzing audio signals according to the invention can also be used for the restoration of old or technically poor audio data. Typical problems of such recordings are hissing, clicking, humming, poor mixing ratios, missing treble or bass. For the suppression of noise, the undesired portions are identified (normally manually) in the residue plane. These are then erased without distortion of the other data. Clicking can be eliminated in an analogous way from the REL plane and humming from the PEL plane. The mixing ratios can be processed by track separation; treble and bass can be resynthesized with the PEL, REL and residue information.

The method for analyzing audio data will now be explained with reference to the embodiment shown in the figures, of which

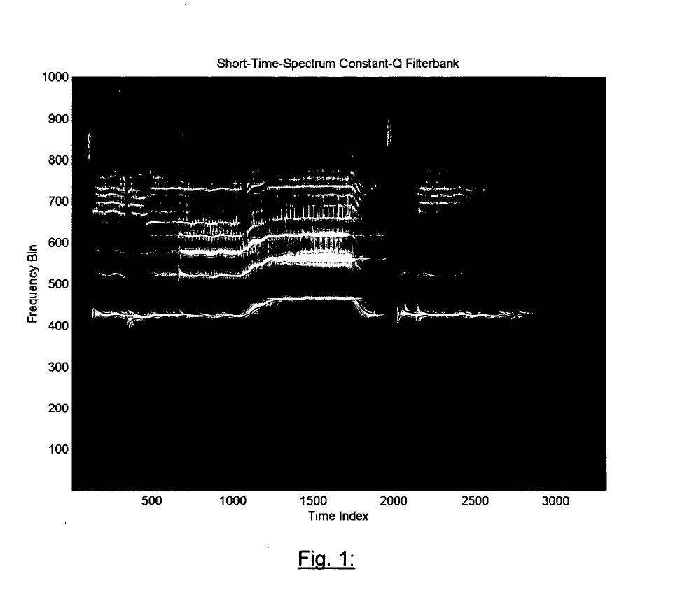

FIG. 1 shows a wavelet filterbank spectrum of a song line,

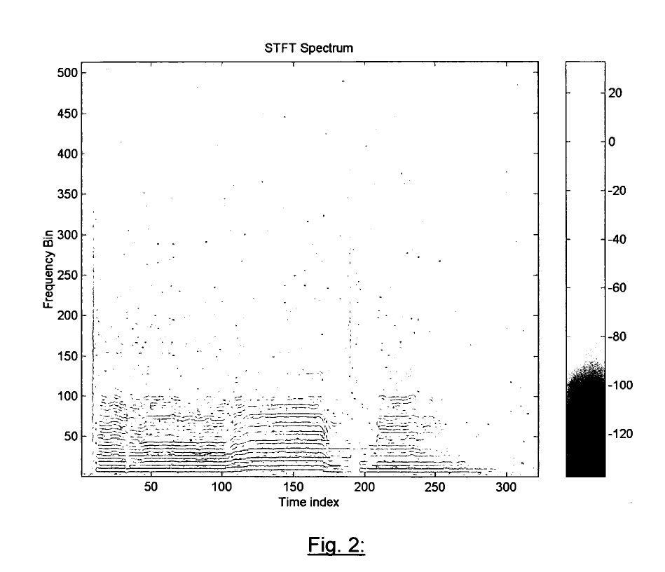

FIG. 2 shows a short-time Fourier spectrum of the song line of FIG. 1,

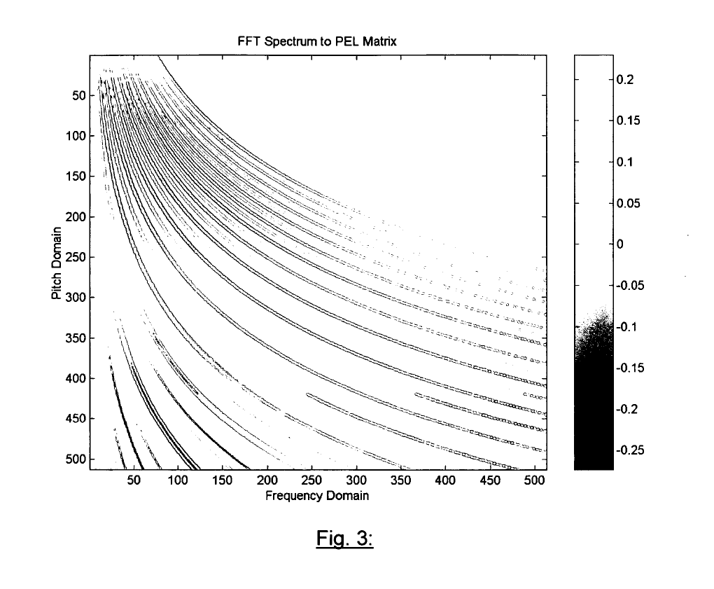

FIG. 3 shows a matrix of the linear mapping of the Fourier spectrum with respect to the PEL,

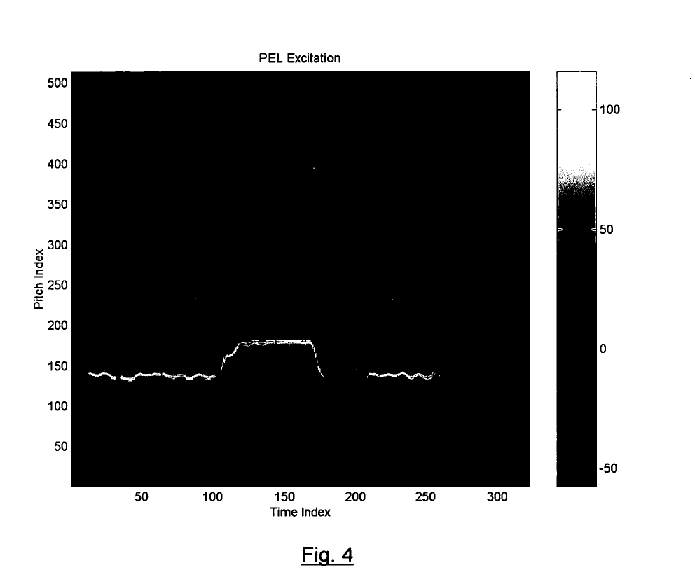

FIG. 4 shows an excitation of the pitch in the PEL, calculated from FIG. 2,

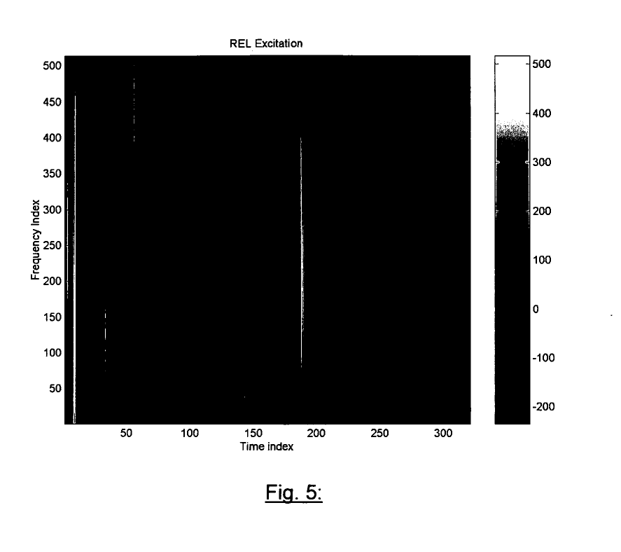

FIG. 5 shows an excitation in the REL, calculated from FIG. 2.

Several possibilities are available for producing short-time spectra. FIG. 1 shows a short-time spectrum of a constant Q filterbank, which corresponds to a wavelet transform. An alternative is offered by Fourier transforms. FIG. 2 shows a short-time Fourier spectrum which was produced with a fast Fourier transform.

For the excitation of the pitch layer, the contrast of the spectrum is increased in one preferred embodiment with lateral inhibition. A correlation with an ideal harmonic spectrum is then carried out. The resulting spectrum is again inhibited laterally. Subsequently, the pitch layer is freed from weak echoes of the harmonics with a decision matrix and is laterally inhibited again in the end. This mapping can be chosen linearly. A possible mapping matrix of the Fourier spectrum from FIG. 2 with respect to the PEL is shown in FIG. 3.

After excitation of the pitch layer, different dominant pitches can be recognized, as e.g. in FIG. 4.

To excite the rhythm layer, a frequency noise suppression can first be carried out and then a time correlation. When this excitation is carried out for FIG. 2, an excitation in the REL as in FIG. 5 can be obtained.

1. A method for analyzing audio signals by
a) generating a series of short-time spectra,
b) non-linear mapping of the short-time spectra into the pitch excitation layer (PEL),
c) non-linear mapping of the short-time spectra into the rhythm excitation layer (REL),
d) extraction of the coherent frequency streams from the audio signal,
e) extraction of the coherent time events from the audio signal,
f) modeling of the residual signal of the audio signal.

2. The method according to claim 1, wherein the short-time spectra are produced by means of short-time Fourier transform, by means of wavelet transform, or by means of a hybrid method consisting of wavelet transform and Fourier transform.

3. The method according to claim 1, wherein the mapping into the pitch excitation layer consists of the correlation of the logarithm of the spectral magnitude with a predetermined ideal harmonic spectrum, suppression of spectral echoes corresponding to the positions of possible harmonics, and of a subsequent separation of the frequency streams.

4. The method according to claim 3, wherein a lateral inhibition is performed according to at least one of the mappings logarithm, correlation and suppression of the echoes.

5. The method according to claim 4, wherein correlation, suppression of the echoes and lateral inhibition are linear mappings.

6. The method according to claim 3, wherein the separation of the frequency streams is carried out with a neuronal network.

7. The method according to claim 3, wherein the separation of the frequency streams is achieved by searching for time-coherent local maxima and calculation of the pitch data as a time series.

8. The method according to claim 1, wherein the mapping into the rhythm excitation layer consists of a linear mapping for frequency noise suppression and for time correlation, which is applied to the logarithm of the spectral magnitude.

9. The method according to claim 8, wherein the time correlation matrix is given by a differential correlation.

10. The method according to claim 1, wherein the extraction of a frequency stream from the audio signal is carried out with a filter having a variable center frequency.

11. The method according to claim 10, wherein the center frequency of the filter is controlled via frequency trajectories from the pitch excitation layer.

12. The method according to claim 10 wherein the extracted signal is multiplied by a complex-valued envelope to adapt the phase with an optimization method.

13. The method according to claim 12, wherein the complex-valued envelope is used for adapting the amplitude of the signal with an optimization method.

14. The method according to claim 1, wherein the frequency streams are calculated as a development according to the band signals of a filterbank, the coefficients being given by projections of a frequency evaluation onto the frequency responses of the filterbank.

15. The method according to claim 1, wherein the extraction of the time events consists of a frequency evaluation and a time domain evaluation.

16. The method according to claim 15, wherein the frequency evaluation is carried out with an FFT filter or an analysis filterbank.

17. The method according to claim 1, wherein the residual signal is statistically modeled.

18. The method according to claim 17, wherein several bands with frequency-localized noise are used for modeling, the bands being added according to a frequency analysis with a time-dependent weighting.

19. The method according to claim 17, wherein the residual signal is modeled by calculating a distribution function from the statistic moments at predetermined time intervals.

20. The method according to claim 19, wherein the interval windows are overlapping with 50% and are then added during resynthesis, evaluated with a triangle window.

21. A method for compressing audio signals by separating the audio signal according to claim 1, and subsequent compression of the PEL streams, REL events and the residual signal.

22. The method according to claim 21, wherein compression comprises the steps of:
a) adaptive double-differential coding of the PEL streams,
b) time-localized coding of the REL events,
c) adaptive differential coding of the residual signal,
d) statistic compression of the data from steps a), b) and c) by entropy maximization.

23. The method according to claim 22, wherein the events for REL coding are given as a linear combination of a finite amount of base vectors.

24. The method according to claim 22, wherein the final compression is carried out with LZW or Huffmann methods.

25. A method for manipulating the time base of signals which have been separated with the method according to claim 18, by
a) determining the envelopes or trajectories of the PEL streams and the envelopes of the noise bands,
b) adapting the time marks of the envelope or trajectory points,
c) adapting the times of the events,
d) adapting the envelope grid points of the noise bands.

26. A method for manipulating the time base of signals which have been separated with the method according to claim 19, by
a) determining the envelopes or trajectories of the PEL streams,
b) adapting the time marks of the envelope or trajectory points,
c) adapting the times of the events,
d) adapting the synthesis window lengths in moment coding.

27. A method for manipulating the tune of signals which have been separated with a method according to claim 1, by shifting the logarithmic frequency trajectories along the frequency axis.

28. A method for manipulating a formant structure of signals which have been separated according to the method according to claim 18, by
a) determining the harmonic amplitudes of PEL streams,
b) interpolating a frequency envelope from the harmonic amplitudes,
c) shifting the frequency envelope,
d) adapting the band frequencies in the noise band representation according to the formant shift.

29. A method for the notation of audio data into musical notes by
a) separating the audio signal according to the method of claim 1,
b) grouping the PEL streams according to their harmonic characteristics into at least one group by means of trainable vector quantizer,
c) identifying the percussive instruments by comparing REL events with low-frequency PEL events or residual signal portions by means of a neuronal network,
d) converting the frequency trajectories of each group and the percussion beats into notations.

30. A method for the track separation of audio data by
a) separating the audio signal according to the method of claim 1,
b) grouping the PEL streams according to their harmonic characteristics by means of a trainable vector quantizer,
c) identifying PEL streams, REL events and residual signal portions pertaining to one group, by means of a neuronal network,
d) resynthesis of the associated streams, events and residual signal portions into one track for each group.

31. A method for identifying an audio signal by separating the signal according to claim 1, and subsequent comparison of the relative positions and types of streams and events with a database.

32. A method for identifying an audio signal by separating the signal according to claim 1, and subsequent comparison of dominant structures with a database.

33. A method for identifying a voice in an audio signal by separating the signal according to claim 1, extrapolation of the formant position from the PEL streams and subsequent comparison with a database.

34. A method according to claim 31, wherein a hashing scheme is used for restricting the selection after separation of the signal and a checksum comparison is thus made with the database.
